(19) United States
(12) Patent Application Publication
(10) Pub. No.: US 2008/0091835 A1
(43) Pub. Date: Apr. 17, 2008

(54) Register/Unregister System And A Register/Unregister Method

(76) Inventor: Lei Yuan, Guangdong Province (CN)

Correspondence Address: LADAS & PARRY LLP, 26 WEST 61ST STREET, NEW YORK, NY, 10023, US

(21) Appl. No.: 11/664,652

(22) PCT Filed: Jun. 30, 2006
(86) PCT No.: PCT/CN06/01518

§ 371 Date: Dec. 28, 2007

(30) Foreign Application Priority Data
Jul. 19, 2005 (CN) 200510085028.0

(51) Int. Cl. G06F 15/16

(52) U.S. Cl. 709/229

(57) ABSTRACT

The present invention discloses a register/unregister system, which comprises: a client end, which is capable of delivering a service request message to the service management server, and capable of delivering a plurality of register/unregister service requests for different services to respective service register/unregister servers based on the information of the plurality of services returned by the service management server; a service management server, which is capable of storing user information, which includes information of a plurality of services, and capable of sending information of the plurality of services to the client end; a service register/unregister server, which is capable of registering/unregistering a service based on the register/unregister service request of each service. According to the invention, a plurality of services may be registered/unregistered at a time, so that time can be saved and good experience will be brought to the users.

### FIELD OF THE INVENTION

The present invention relates to network communication technology, in particular, to register/unregister system and method and client end thereof.

### BACKGROUND OF THE INVENTION

In modern communication systems, such as in NGN (Next Generation Network), a lot of new services come into sight end to end and bring about an abundance of experiences to the users. As a result, users may need to apply for a plurality of services quite possibly to enjoy them. However, in the prior art such as SIP (Session Initiation Protocol) of NGN, in order to use a plurality of applied services, only one service may be registered/unregistered at a time. Therefore, in order to be able to enjoy a plurality of services, a user has to register/unregister each service needed one by one, which makes service-registering/unregistering a time-consuming task.

### SUMMARY OF THE INVENTION

The invention embodiment provides a register/unregister system, including a client end, a service management server and at least one service register/unregister server, wherein:

the client end is capable of delivering a service request message to the service management server, and capable of delivering a plurality of register/unregister service requests for different services to respective service register/unregister servers based on the information of the plurality of services returned by the service management server;

the service management server is capable of storing user information, which includes information of a plurality of services, and capable of sending information of the plurality of services to the client end; and

the service register/unregister server is capable of registering/unregistering a service based on the register/unregister service request of each service.

The invention embodiment further provides a register/unregister method, which includes:

delivering, by the client end, service request message to a service management server;

obtaining information of a plurality of services based on the service request information and sending the information of the plurality of services to the client end by a service management server;

generating, by the client end, a plurality of register/unregister service requests for different services via the client end based on the information of the plurality of services and delivering a plurality of register/unregister service requests for the different services to the respective service register/unregister servers; and

registering/unregistering, by the service register/unregister servers, a plurality of services based on the register/unregister service request of a plurality of services.

The embodiments of the present invention further provide a client end, including:

a component configured to:

deliver register/unregister service request to a service management server, said register/unregister service request comprises a plurality of services;

generate a plurality of register/unregister service requests for different services based on the information of a plurality of services received from the service management server; and

deliver the plurality of register/unregister service requests for different services to respective service register/unregister servers.

The embodiments of the present invention further provide a service management server, comprising:

a component configured to:

store user information, the user information comprises information of a plurality of services;

send the information of a plurality of services to client end.

According to the invention, a plurality of services may be registered/unregistered at a time, so that users need not to register/unregister each service one by one after applying for the plurality of services. As a result, time can be saved and good experience will be brought to the users.

### BRIEF DESCRIPTION OF THE DRAWINGS

FIG. 1 is a schematic diagram of the register/unregister system according to an embodiment of the present invention;

FIG. 2 shows a flow chart of the register/unregister method according to an embodiment of the present invention;

FIG. 3 shows a register method according to an embodiment of the present invention; and

FIG. 4 shows an unregister method according to an embodiment of the present invention.

### DETAILED DESCRIPTION OF THE EMBODIMENTS

In order to better understand and implement the present invention, embodiments of the invention will now be described with reference to the accompanying drawings.

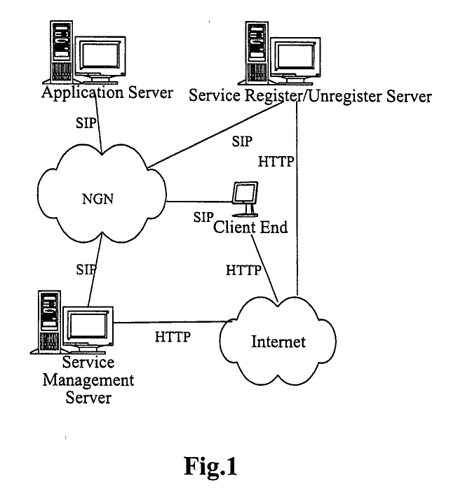

An embodiment of the present invention provides a register/unregister system as shown in FIG. 1, which includes: a communication network, a client end, a service management server, a service register/unregister server and an application server. Hereinbelow, this register/unregister system will described in detail.

The communication network includes a NGN and/or the Internet, for connecting the client end, application server, service register/unregister server and service management server, which enables the communication therebetween. When the above mentioned devices are connected via an NGN, SIP may be used for communication; when they are connected via the Internet, HTTP (Hypertext Transfer Protocol) may be used for communication.

The client end is connected with the service management server via a communication network to generate service request message, deliver the generated service request message to the service management server and deliver register/unregister service request of each service to the service register/unregister server based on predefined rules and the register/unregister information of each service returned by the service management server. The service request message includes a user name and a user password. The client end includes an encryption component, the encryption component is configured to encrypt the service request message and/or the register/unregister service request.

The service management server is used to store user information. The user information includes a user name, a user password and information of each service corresponding to the user. The service information includes a service account, a service password, a service register/unregister server address, information of register mode and encryption mode, etc. The service management server further comprises: a decryption component, the decryption component is configured to decrypt the encrypted service request message; an authentication component, the authentication component is configured to authenticate the service request message based on the user information.

The service register/unregister server is used to register/unregister each service based on the register/unregister service request of each service and can determine whether to permit a user to use the applied service according to the register situation of the user. The service register/unregister server may be an application server (AS), a Soft Exchange Server or other servers in its physical embodiment.

The application server is used to execute various services.

The invention further provides a register/unregister method by which a plurality of services may be registered/unregistered at a time. The register/unregister method will now be described in detail in the following.

First of all, a user may activate a plurality of services in a business hall or via communication network and obtain relevant service information, then store the service information into a table of user information on a service management server.

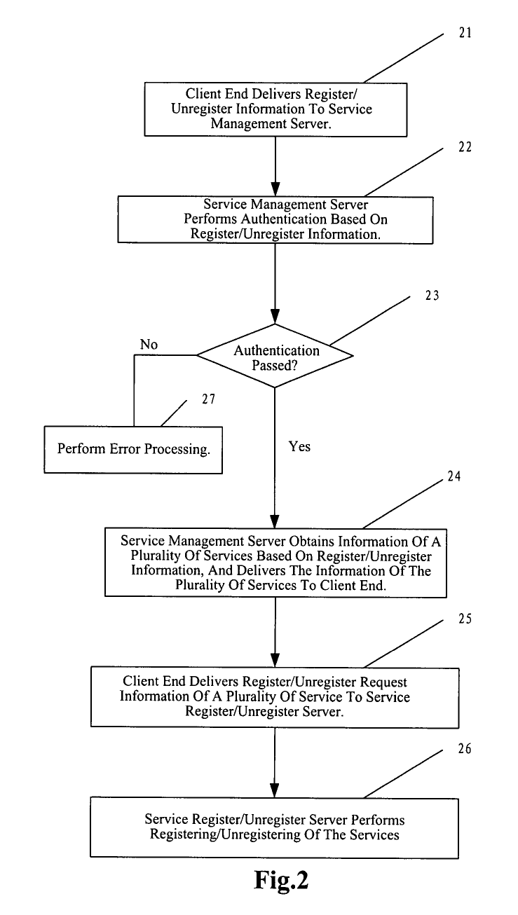

As shown in FIG. 2, in Step 21, a client end delivers service request message to a service management server. The service request message includes a user name and a user password. In order to ensure the security of the user information, it may be encrypted on the client end. For example, DES (Data Encryption Standard) and the like may be used to encrypt the service request message.

The client end may deliver service request message to the service management server at various occasions. For example, service request message may be delivered after the client end receives a user register/unregister request, at a preset time or at fixed time intervals.

The client end may deliver service request message to the service management server in various ways. For example, service request message may be delivered to the service management server in HTTP and the like via Internet, or in SIP and the like via NGN.

In Step 22, the service management server decrypts the encrypted service request message at first, and then authenticates the service request message based on the user information, i.e., verifies whether the user name is consistent with the user password. If the user name is consistent with the user password, then the authentication will be passed; otherwise, it fails.

In Step 23, determine whether the authentication has been passed. If yes, then go to Step 24; otherwise, turn to Step 27.

In Step 24, after the authentication has been passed, the service management server extracts the service information of the user and delivers the service information to the client end. The service information includes the information of a plurality of services.

In Step 25, the client end generates register/unregister service requests of a plurality of services based on the service information delivered by the service management server and delivers the register/unregister service requests of the services to a service register/unregister server based on predefined rules.

In Step 26, the service register/unregister server performs registering/unregistering of a service based on the register/unregister service request of the service.

In Step 27, error processing is performed. The client end may be prompted that the user name is inconsistent with the password, and the user may be required to resubmit the service request message and perform Step 21 to 23 again until the authentication is passed, or if the authentication has not been passed after predetermined submission times (for example, 5 times), the register/unregister request of the user can be rejected. In the invention, if the authentication is not passed after the register/unregister request has been submitted 5 times, then the register/unregister request of the user will be rejected and the user will be prompted to reset user password in the business hall carrying with his/her valid certificate.

The predefined rules refer to register/unregister order. For example, register/unregister may be applied for in the service register/unregister server one by one in a predetermined priority order or randomly.

In order to make the user aware of the register/unregister status, the client end may return a successful register/unregister message to the user after all of the services have been registered/unregistered, or may return a successful register/unregister message to the user after a key service register/unregister is completed, so that the user may know that whether certain service has been successfully registered/unregistered or not.

The register/unregister mode of each service may be determined when the service is applied for and be configured when the service is distributed. The service register/unregister mode may be configured as a standard SIP register/unregister process, a network station HTTP/HTTPS register/unregister process or any customized register/unregister process according to the different modes applied.

It should be noted that the service register/unregister servers corresponding to each service may be different or be the same with each other.

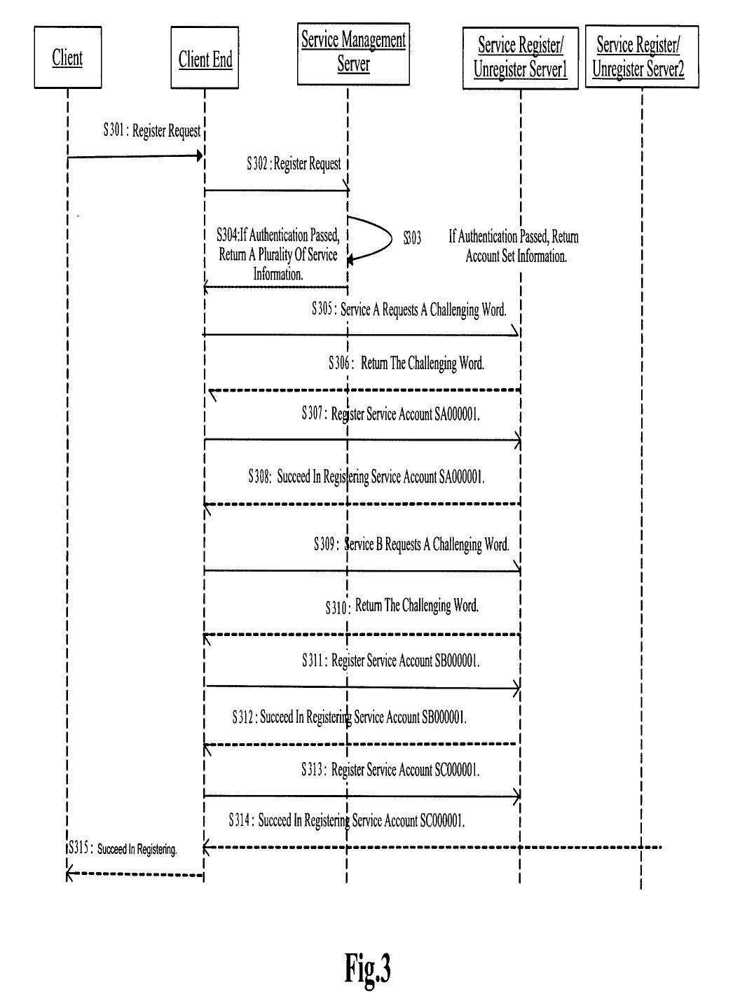

As shown in FIG. 3, a process for registering a plurality of services at a time will now be illustrated, taking NGN service as an example. It is assumed that there exists a user in a NGN with a user name of Ray and a user password of RayPwd, who has applied to activate three NGN services: service A, service B and service C, the client end address is Ray@192.0.2.4, and the information of the service register/unregister server is shown in Table 1.

TABLE 1
Information Table Of The Service Register/Unregister Server

| Server | | | |
|---|---|---|---|
| Name | Server Address | Server Type | Notes |
| AMS1 | www.AMS1.com:8001/registrar.do | Account | Service |
| | | Management | Management |
| | | Server | Server |
| ARS1 | ARS1.com:5060 | Account | Service |
| | | Registration | Register/Un- |
| | | Server | register |
| | | | Server |
| ARS2 | www.ARS2.com:8002/registrar.do | Account | Service |
| | | Registration | Register/Un- |
| | | Server | register |
| | | | Server |

Table 2 shows the user information.

TABLE 2
Table of User Information

| User Name | User Password | Client End Address | Notes |
|---|---|---|---|
| Ray | RayPwd | Ray@192.0.2.4 | |

Table 3 shows the information of the services.

TABLE 3
Table Of User Service Information

| | | | |
|---|---|---|---|
| User | Ray | Ray | Ray |
| Service | Service A | Service B | Service C |
| Service Account | SA000001 | SB000001 | SC000001 |
| Service Account | SA000001Pwd | SB000001Pwd | SC000001Pwd |
| Password | | | |
| Service Register/Un- | ARS1 | ARS1 | ARS2 |
| register Server | | | |
| Register Mode | Standard SIP | Standard SIP | HTTP Register |
| | Register | Register | |
| Register Encryption | MD5 | MD5 | Not Encrypted |
| Register Priority | High | Medium | Low |
| Must Be Registered | Yes | Yes | Yes |
| Unregister Priority | High | Medium | Low |
| Must Be Unregistered | Yes | Yes | Yes |
| Notes | | | |

In Step 301, the user Ray inputs user name Ray and password RayPwd via client end interface, then clicks a button to submit the service request message;

In Step 302, the client end encapsulates the information, such as user name Ray and password RayPwd, into a packet and sends it to AMS1. In order to ensure the security of the user information, the user information, such as user name and password, may be encrypted, and then the encrypted user information will be sent to AMS1. The following is an exemplary message of service request message sent from a client end to AMS1.

S2 REGISTER Client ->AMS1, the exemplary message is as follows:

POST http://www.AMS1.com:8001/registrar.do HTTP/1.1
Content-Type: application/x-www-form-urlencoded
Accept-Encoding: gzip, deflate
Content-Length: 40
Connection: Keep-Alive
Cache-Control: no-cache
name=Ray&password=RayPwd&clientaddr=Ray@192.0.2.4&method=login

&submit=submit

In Step 303, after AMS1 receives the HTTP packet from the client end, it will resolve the packet and obtain the user name and the password. If the packet has been encrypted, a decryption operation will be required. Then, AMS1 will perform authentication by verifying the user name and password sent by the client end with the user information stored on AMS1 (See Table 2: Table Of User Information).

In Step 304, if the authentication is passed, then the service management server extracts the service information corresponding to the user stored thereon (See Table 3: Table Of User Service Information); then the service management server delivers the service information corresponding to the user to the client end;

S4 200 OK AMS1->Client, an exemplary message is as follows:

HTTP/1.1 200 OK
Set-Cookie:

JSESSIONID=87D42196E7BB95A3F45D19FQE31CD62F

Content-Type: text/html;charset=gb2312
Content-Length: 20
Connection: close
<registrar>

<accountVectorInfo>

<accountinfo>

<username>Ray</userName>
<serviceName>Service A<serviceName>
<account>SA000001</response>

<password>SA000001Pwd</password>

<registServer>ARS1</registServer>
<registMethod>SIP</registMethod>
<registDecode>MD5<registDecode>
<loginPriority>High</loginPriority>
<loginMust>Yes</loginMust>
<logoutPriority>High</logoutPriority>
<logoutMust>Yes</logoutMust>

</accountinfo>
<accountinfo>

<username>Ray</userName>
<serviceName>Service B<serviceName>
<account>SB000001</response>

<password>SB000001Pwd</password>

<registServer>ARS1</registServer>
<registMethod>SIP</registMethod>
<registDecode>MD5<registDecode>
<loginPriority>Mid</loginPriority>
<loginMust>Yes</loginMust>
<logoutPriority>Mid</logoutPriority>
<logoutMust>Yes</logoutMust>

</accountinfo>
<accountinfo>

<username>Ray</userName>
<serviceName>Service C<serviceName>
<account>SC000001</response>

<password>SC000001Pwd</password>

<registServer>ARS2</registServer>
<registMethod>HTTP</registMethod>
<registDecode>NO<registDecode>
<loginPriority>Low</loginPriority>
<loginMust>Yes</loginMust>
<logoutPriority>Low</logoutPriority>
<logoutMust>Yes</logoutMust>

</accountinfo>

<accountVectorInfo>

</registrar>

The client end will register all of the services based on the service information according to the predefined priority.

Service A has the highest priority, so it will be processed firstly.

In Step 305, since the register mode of service A is a standard SIP mode, the client end will request a challenging word from ARS1, so that the client end may encrypt the register request of service A according to the challenging word. The challenging word acts as a key. In Step 306, ARS1 delivers a challenging word to the client end. In Step 307, the client end encrypts the register request information of service A based on the challenging word and then delivers it to ASR1. That is, AMS1 cooperates with ARS1 to complete the register of service A. The following is an example of the messages of the register process of service A.

S5 REGISTER Client->ARS1, an exemplary message is as follows:

REGISTER sip: ARS1.com SIP/2.0
Via: SIP/2.0/UDP temp.ARS1.com:5080
Max-Forwards: 70
To: Ray<sip:Ray@ARS1.com>;
From: Ray<sip:Ray@ARS1.com>;tag=456248
Call-ID: 843817637684230@temp.ARS1.com
CSeq: 1 REGISTER
Contact: <sip:Ray@192.0.2.4>
User-Agent: Service A/1.0
Expires: 72000
Content-Length: 0

S6 401 with Authorization ARS1->Client, an exemplary information is as follows:

| SIP/2.0 401 Unauthorized | |
|---|---|
| Allow: INVITE,ACK,BYE,CANCEL,OPTIONS,REGISTER | |
| Via: SIP/2.0/UDP temp.ARS1.com:5080 | |
| To: Ray<sip:Ray@ARS1.com>;tag=2493k59kd | |
| From: Ray<sip:Ray@ARS1.com>;tag=456248 | |
| Call-ID: 843817637684230@temp.ARS1.com | |
| CSeq: 1 REGISTER | |
| Contact: <sip:ARS1.com> | |
| Expires: 72000 | |
| Content-Length: 0 | |
| www-Authenticate: | Digest |

qop=“auth”,nonce=“BJbQ.001”,algorithm=“md5”,realm=“ARS1.com”

S7 REGISTER Client->ARS1, an exemplary message is as follows:

REGISTER sip: ARS1.com SIP/2.0
Via: SIP/2.0/UDP temp.ARS1.com:5080
Max-Forwards: 70
To: Ray<sip:Ray@ARS1.com>;tag=2493k59kd
From: Ray<sip:Ray@ARS1.com>;tag=456248
Call-ID: 843817637684230@temp.ARS1.com
CSeq: 2 REGISTER
Contact: <sip:Ray@192.0.2.4>

User-Agent: Service A/1.0

Expires: 72000
Content-Length: 0
Authorization: Digest algorithm=“md5”,
cnonce=“51f308670-0972-809d-3409a-4a091d1d09”,
nc=00000001,nonce=“BJbQ.001”,qop=“auth”,realm=“ARS1.com”,
response=“1ac17228a5e400a99f378eeedf87aa2c”,
uri=“sip:ARS1.com”,username=SA000001@ARS1.com

S8 200 OK ARS1->Client, an exemplary information is as follows:

SIP/2.0 200 OK
Allow: INVITE, ACK, BYE, CANCEL, OPTIONS, REGISTER,
SUBSCRIBE, NOTIFY, INFO
Via: SIP/2.0/UDP temp.ARS1.com:5080
To: Ray<sip:Ray@ARS1.com>;tag=2493k59kd
From: Ray<sip:Ray@ARS1.com>;tag=456248
Call-ID: 843817637684230@temp.ARS1.com
CSeq: 2 REGISTER
Contact: <sip:ARS1.com>
User-Agent: Service A/1.0
Expires: 72000
Content-Length: 0

In Step 308, after the register of service A is completed, ARS1 returns a successful register information or failed register information to the client end according to the register status of service A.

Since service B has a relatively higher priority, so it should now be processed.

In Step 309, since the register mode of service B is a standard SIP mode, the client end will request a challenging word from ARS1, so that the client end may encrypt the register request of service B according to the challenging word. The challenging word acts as a key. In Step 310, ARS1 delivers a challenging word to the client end. In Step 311, the client end encrypts the register request information of service B according to the challenging word and then delivers it to ASR1. The following is an example of the messages of the register process of service B.

S9 REGISTER Client->ARS1, an exemplary message is as follows:

REGISTER sip: ARS1.com SIP/2.0
Via: SIP/2.0/UDP temp.ARS1.com:5080
Max-Forwards: 70
To: Ray<sip:Ray@ARS1.com>;
From: Ray<sip:Ray@ARS1.com>;tag=456248
Call-ID: 843817637684230@temp.ARS1.com
CSeq: 1 REGISTER
Contact: <sip:Ray@192.0.2.4>
User-Agent: Service B/1.0
Expires: 72000
Content-Length: 0

S10 401 with Authorization ARS1->Client, an exemplary information is as follows:

| SIP/2.0 401 Unauthorized | |
|---|---|
| Allow: INVITE,ACK,BYE,CANCEL,OPTIONS,REGISTER | |
| Via: SIP/2.0/UDP temp.ARS1.com:5080 | |
| To: Ray<sip:Ray@ARS1.com>;tag=2493k59kd | |
| From: Ray<sip:Ray@ARS1.com>;tag=456248 | |
| Call-ID: 843817637684230@temp.ARS1.com | |
| CSeq: 1 REGISTER | |
| Contact: <sip:ARS1.com> | |
| Expires: 72000 | |
| Content-Length : 0 | |
| www-Authenticate: | Digest |

qop=“auth”,nonce=“BJbQ.001”,algorithm=“md5”,realm=“ARS1.com”

S11 REGISTER Client ->ARS1, an exemplary message is as follows:

REGISTER sip: ARS1.com SIP/2.0
Via: SIP/2.0/UDP temp.ARS1.com:5080
Max-Forwards: 70
To: Ray<sip:Ray@ARS1.com>;tag=2493k59kd
From: Ray<sip:Ray@ARS1.com>;tag=456248
Call-ID: 843817637684230@temp.ARS1.com
CSeq: 2 REGISTER
Contact: <sip:Ray@192.0.2.4>
User-Agent: Service B/1.0
Expires: 72000
Content-Length: 0
Authorization: Digest algorithm=“md5”,
cnonce=“51f308670-0972-809d-3409a-4a091d1d09”,
nc=00000001,nonce=“BJbQ.001”,qop=“auth”,realm=“ARS1.com”,
response=“1ac17228a5e400a99f378eeedf87aa2c”,
uri=“sip:ARS1.com”,username=SB000001@ARS1.com

S12 200 OK ARS1->Client, an exemplary information is as follows:

SIP/2.0 200 OK
Allow: INVITE, ACK, BYE, CANCEL, OPTIONS, REGISTER,

SUBSCRIBE, NOTIFY, INFO

Via: SIP/2.0/UDP temp.ARS1.com:5080
To: Ray<sip:Ray@ARS1.com>;tag=2493k59kd
From: Ray<sip:Ray@ARS1.com>;tag=456248
Call-ID: 843817637684230@temp.ARS1.com
CSeq: 2 REGISTER
Contact: <sip:ARS1.com>
User-Agent: Service B/1.0
Expires: 72000
Content-Length: 0

In Step 312, after the register of service B is completed, ARS1 returns a successful register information or failed register information to the client end according to the register status of service B.

Now, only service C is left, which will be processed by the client end.

In Step 313, since the register mode of service C is HTTP mode, the client end will deliver the register request information of the service to ASR2. In Step 314, after the register of service C is completed, ARS2 returns a successful register information or failed register information to the client end according to the register status of service C. The following is an example of the messages of the register process of service C.

S13 REGISTER Client ->ARS2, an exemplary message is as follows:

POST http://www.ARS2.com:8002/registrar.do HTTP/1.1
Content-Type: application/x-www-form-urlencoded
Content-Length: 140
Connection: Keep-Alive
Cache-Control: no-cache
<registrar>

<method>login</method>
<serviceinfo>

<servicename>Service C</servicename>

</serviceinfo>
<accountinfo>

<account>SC000001</response>

<password>SC000001Pwd</password>
</accountinfo>
<clientinfo>

<clientaddr>Ray@192.0.2.4</clientaddr>

</clientinfo>

</registrar>

S14 200 OK ARS2->Client, an exemplary message is as follows:

HTTP/1.1 200 OK
Set-Cookie:
JSESSIONID=87D42196E7BB95A3F45D19FAF31AB62F

Content-Type: text/html;charset=gb2312
Content-Length: 104
Connection: close
<registrar>

<response>

<rspcode>1</rspcode>

</response>

</registrar>

In Step 315, since all of the three services corresponding to the user must be registered, if all of the services are registered successfully, then successful register information will be returned; otherwise, failed register information will be returned.

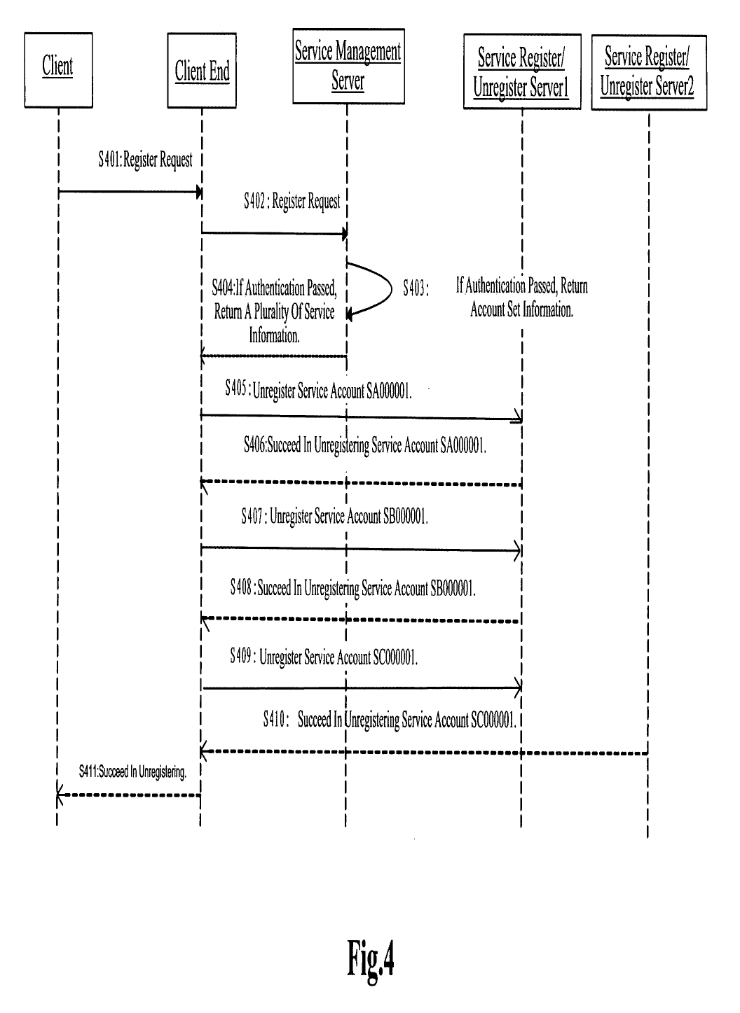

As shown in FIG. 4, an unregister process will be described in the following.

In Step 401, the user Ray inputs user name Ray and password RayPwd via client end interface, then clicks a button to submit the service request message;

In Step 402, the client end encapsulates the information, such as user name Ray and password RayPwd, into a packet and sends it to AMS1. In order to ensure the security of the user information, the user information, such as user name and password, may be encrypted firstly, and then the encrypted user information will be sent to AMS1. The following is an exemplary message of service request message sent from a client end to AMS1.

S2 REGISTER Client->AMS1, an exemplary message is as follows:

POST http://www.AMS1.com:8001/registrar.do HTTP/1.1
Content-Type: application/x-www-form-urlencoded
Accept-Encoding: gzip, deflate
User-Agent: Mozilla/4.0 (compatible; MSIE 6.0; Windows NT 5.1)
Content-Length: 40
Connection: Keep-Alive
Cache-Control: no-cache
Cookie: JSESSIONID=87D42196E7BB95A3F45D19FQE31CD62F
name=Ray&password=RayPwd&clientaddr=Ray@192.0.2.4&method=logout

&submit=submit

In Step 403, after receiving a HTTP packet sent by a client end, AMS1 will resolve the packet and obtain a user name and a password. If the packet has been encrypted, then a decryption operation will be required. Then, AMS1 performs authentication by verifying the user name and password sent by the client end with the user information stored on AMS1 (See Table 2: Table Of User Information).

In Step 404, if the authentication is passed, then the service management server extracts the service information corresponding to the user stored thereon (See Table 3: Table Of User Service Information); then the service management server delivers the service information corresponding to the user to the client end;

S4 200 OK AMS1->Client, an exemplary message is as follows:

HTTP/1.1 200 OK
Set-Cookie:
JSESSIONID=87D42196E7BB95A3F45D19FQE31CD62F
Content-Type: text/html;charset=gb2312
Content-Length: 20
Connection: close
<registrar>

<accountVectorInfo>

<accountinfo>

<username>Ray</userName>
<serviceName>Service A<serviceName>

<account>SA000001</response>

<password>SA000001Pwd</password>

<registServer>ARS1</registServer>
<registMethod>SIP</registMethod>
<registDecode>MD5<registDecode>
<loginPriority>High</loginPriority>
<loginMust>Yes</loginMust>
<logoutPriority>High</logoutPriority>
<logoutMust>Yes</logoutMust>

</accountinfo>

<accountinfo>

<username>Ray</userName>
<serviceName>Service B<serviceName>

<account>SB000001</response>

<password>SB000001Pwd</password>

<registServer>ARS1</registServer>
<registMethod>SIP</registMethod>
<registDecode>MD5<registDecode>
<loginPriority>Mid</loginPriority>
<loginMust>Yes</loginMust>
<logoutPriority>Mid</logoutPriority>
<logoutMust>Yes</logoutMust>

</accountinfo>

<accountinfo>

<username>Ray</userName>
<serviceName>Service C<serviceName>

<account>SC000001</response>

<password>SC000001Pwd</password>

<registServer>ARS2</registServer>
<registMethod>HTTP</registMethod>
<registDecode>NO<registDecode>
<loginPriority>Low</loginPriority>
<loginMust>Yes</loginMust>
<logoutPriority>Low</logoutPriority>
<logoutMust>Yes</logoutMust>

</accountinfo>

<accountVectorInfo>

</registrar>

The client end will unregister all of the services based on the service information according to the predefined priority.

Since service A has the highest priority, so it will be processed firstly.

In Step 405, the client end delivers an unregister request of service A to ARS1. The only difference between the unregister request message and the register request message delivered by the client end lies in that the value of the Expires field of the unregister request message is 0.

In Step 406, after the unregister of service A is completed, ARS1 returns a successful unregister information or failed unregister information to the client end according to the unregister status of service A.

S4 REGISTER Client->ARS1, an exemplary message is as follows:

REGISTER sip: ARS1.com SIP/2.0
Via: SIP/2.0/UDP temp.ARS1.com:5080
Max-Forwards: 70
To: Ray<sip:Ray@ARS1.com>;
From: Ray<sip:Ray@ARS1.com>;tag=456248
Call-ID: 843817637684230@temp.ARS1.com
CSeq: 3 REGISTER
Contact: <sip:Ray@192.0.2.4>
User-Agent: Service A/1.0
Expires: 0
Content-Length: 0

S5 200 OK ARS1->Client, an exemplary information is as follows:

SIP/2.0 200 OK
Allow: INVITE, ACK, BYE, CANCEL, OPTIONS, REGISTER
Via: SIP/2.0/UDP temp.ARS1.com:5080
To: Ray<sip:Ray@ARS1.com>
From: Ray<sip:Ray@ARS1.com>;tag=456248
Call-ID: 843817637684230@temp.ARS1.com
CSeq: 3 REGISTER
Contact: <sip:ARS1.com>
User-Agent: Service A/1.0
Expires: 0
Content-Length: 0

Since service B has a relatively higher priority, so it should now be processed.

In Step 407, the client end delivers an unregister request of service B to ARS1. The only difference between the unregister request message and the register request message delivered by the client end lies in that the value of the Expires field of the unregister request message is 0.

In Step 408, after the unregister of service B is completed, ARS1 returns a successful unregister information or failed unregister information to the client end according to the unregister status of service B.

S6 REGISTER Client->ARS1, an exemplary message is as follows:

REGISTER sip: ARS1.com SIP/2.0
Via: SIP/2.0/UDP temp.ARS1.com:5080
Max-Forwards: 70
To: Ray<sip:Ray@ARS1.com>;
From: Ray<sip:Ray@ARS1.com>;tag=456248
Call-ID: 843817637684230@temp.ARS1.com
CSeq: 3 REGISTER
Contact: <sip:Ray@192.0.2.4>
User-Agent: Service A/1.0
Expires: 0
Content-Length: 0

S7 200 OK ARS1->Client, an exemplary information is as follows:

SIP/2.0 200 OK
Allow: INVITE, ACK, BYE, CANCEL, OPTIONS, REGISTER
Via: SIP/2.0/UDP temp.ARS1.com:5080
To: Ray<sip:Ray@ARS1.com>
From: Ray<sip:Ray@ARS1.com>;tag=456248
Call-ID: 843817637684230@temp.ARS1.com
CSeq: 3 REGISTER
Contact: <sip:ARS1.com>
User-Agent: Service A/1.0
Expires: 0
Content-Length: 0

Finally, service C will be processed.

In Step 409, the client end delivers an unregister request to ARS2. In Step 410, after the unregister of service C is completed, ARS2 returns a successful unregister information or failed unregister information to the client end according to the unregister status of service C.

S8 REGISTER Client->ARS2, an exemplary message is as follows:

POST http://www.ARS2.com:8002/registrar.do HTTP/1.1
Content-Type: application/x-www-form-urlencoded
Content-Length: 140
Connection: Keep-Alive
Cache-Control: no-cache
Cookie: JSESSIONID=87D42196E7BB95A3F45D19FAF31AB62F
<registrar>

<method>logout</method>
<serviceinfo>

<servicename>Service C</servicename>

</serviceinfo>
<accountinfo>

<account>SC000001</response>

<password>SC000001Pwd</password>
</accountinfo>
<clientinfo>

<clientaddr>Ray@192.0.2.4</clientaddr>

</clientinfo>

</registrar>

S9 200 OK ARS2->Client, an exemplary message is as follows:

HTTP/1.1 200 OK
Content-Type: text/html;charset=gb2312
Content-Length: 104
Connection: close
<registrar>

<response>

<rspcode>1</rspcode>

</response>

</registrar>

In Step 411, since all of the three services corresponding to the user must be unregistered, so if all of the services are unregistered successfully, then a successful unregister information will be returned; otherwise, a failed unregister information will be returned.

It should be noted that in the user information of a service management server, each service may correspond to one and the same user name and user password, or it may correspond to different user names and user passwords. In the latter case, the service request message delivered to the service management server by a client end should include the user name and the user password corresponding to each service.

According to the invention, a plurality of services may be registered/unregistered at a time, so that users need not to register/unregister each service one by one after applying for a plurality of services. As a result, time can be saved and good experience will be brought to the users, which is beneficial for service integration.

Although the present invention has been described with the above embodiments, however, additional advantages and modifications will readily occur to those skilled in the art, without departing from the spirit or scope of the invention. The scope of the present invention should be defined by the appended claims and their equivalents.

1. A register/unregister system, comprising a client end, a service management server and at least one service register/unregister server wherein:
the client end is capable of delivering a service request message to the service management server, and capable of delivering a plurality of register/unregister service requests for different services to respective service register/unregister servers based on the information of the plurality of services returned by the service management server;
the service management server is capable of storing user information, which includes information of a plurality of services, and capable of sending information of the plurality of services to the client end; and
the service register/unregister server is capable of registering/unregistering a service based on the register/unregister service request of each service.

2. The register/unregister system according to claim 1, wherein the client end further comprises an encryption component, the encryption component is configured to encrypt the register/unregister service request.

3. The register/unregister system according to claim 2, wherein the service management server further comprises a decryption component, the decryption component is configured to decrypt the encrypted register/unregister service request.

4. The register/unregister system according to claim 1, wherein the service management server further comprises an authentication component, the authentication component is configured to authenticate the register/unregister service request.

5. The register/unregister system according to claim 1, further comprising the client end delivering a plurality of register/unregister service requests for different services to the respective service register/unregister servers based on predefined rules.

6. A register/unregister method, comprising:
delivering, by the client end, service request message to a service management server;
obtaining information of a plurality of services based on the service request information and sending the information of the plurality of services to the client end by a service management server;
generating, by the client end, a plurality of register/unregister service requests for different services via the client end based on the information of the plurality of services and delivering a plurality of register/unregister service requests for the different services to the respective service register/unregister servers; and
registering/unregistering, by the service register/unregister servers, a plurality of services based on the register/unregister service request of a plurality of services.

7. The register/unregister method according to claim 6, further comprising encrypting the register/unregister service request.

8. The register/unregister method according to claim 7, further comprising decrypting the encrypted register/unregister service request by the service management server.

9. The register/unregister method according to claim 6, further comprising authenticating the register/unregister service request by the service management server.

10. The register/unregister method according to claim 6, further comprising delivering a plurality of register/unregister service requests for different services to the respective service register/unregister servers based on predefined rules by the client end.

11. The register/unregister method according to claim 10, wherein the predefined rules further comprising random register/unregister or priority-based register/unregister.

12. A client end, comprising:
a component configured to:
deliver register/unregister service request to a service management server, said register/unregister service request comprises a plurality of services;
generate a plurality of register/unregister service requests for different services based on the information of a plurality of services received from the service management server; and
deliver the plurality of register/unregister service requests for different services to respective service register/unregister servers.

13. The client end according to claim 12, wherein the component is further configured to encrypt the register/unregister service request.

14. The client end according to claim 12, wherein the component is further configured to obtain predefined rules, the client end delivers the plurality of register/unregister service requests for different services to the respective service register/unregister servers based on the predefined rules.

15. A service management server, comprising:
a component configured to:
store user information, the user information comprises information of a plurality of services;
send the information of a plurality of services to client end.

16. The service management server according to claim 15, wherein the component is further configured to decrypt the encrypted register/unregister service request.

17. The service management server according to claim 15, wherein the component is further configured to authenticate the register/unregister service request.

18. The service management server according to claim 16, wherein the component is further configured to authenticate the register/unregister service request.
